(19) United States
(12) Patent Application Publication
(10) Pub. No.: US 2012/0154555 A1
(43) Pub. Date: Jun. 21, 2012

(54) STEREOSCOPIC IMAGE DISPLAY DEVICE AND STEREOSCOPIC IMAGE DISPLAY METHOD

(76) Inventors: Yuki IWANAKA, Yokohama-Shi (JP); Takeshi Mita, Yokohama-Shi (JP); Masahiro Baba, Yokohama-Shi (JP)

(21) Appl. No.: 13/234,886

(22) Filed: Sep. 16, 2011

(30) Foreign Application Priority Data
Dec. 15, 2010 (JP) 2010-279783

(51) Int. Cl. H04N 13/04

(52) U.S. Cl. 348/51; 348/E13.075

(57) ABSTRACT

A correction unit corrects gradation of pixels of a processing-target image signal for the right eye or the left eye. A writing unit writes the corrected image signal into display pixels of an image displaying unit. A reached level calculation unit calculates a reached gradation which is a gradation to be reached by each display pixel after one sub-frame period after the corrected image signal is written into the display pixel, on the basis of response characteristics of the display pixel, respectively. A timing controlling unit controls opening/closing timing of the glasses according to writing timing of the writing unit. The correction unit corrects the gradation of the pixels of the processing-target image signal, respectively, on the basis of a difference between the writing timing of the writing unit and the opening/closing timing of the glasses, and the reached gradation of the pixels in an immediately previous sub-frame.

### CROSS REFERENCE TO RELATED APPLICATIONS

This application is based upon and claims the benefit of priority from the prior Japanese Patent Application No. 2010-279783, filed on Dec. 15, 2010, the entire contents of which are incorporated herein by reference.

### FIELD

Embodiments of the present invention relate to a stereoscopic image display device and stereoscopic image display method causing an observer wearing special glasses to watch three-dimensional (3D) video images, for example, by displaying video images for a plurality of viewpoints on the same screen by time sharing.

### BACKGROUND

As one of stereoscopic (three-dimensional) displays, a time-sharing stereoscopic display has been developed in which a video image for a plurality of viewpoints is displayed on the screen by time sharing. Two types of time-sharing stereoscopic display, a glasses type and an auto-stereoscopic method have been proposed. The glasses type is a type of using special glasses to separate a left-eye image and a right-eye image, and it is currently used for showing of a stereoscopic film and the like. The auto-stereoscopic method is a type of separating viewpoint images by giving directionality to backlight.

When an image is displayed on a time-sharing stereoscopic image display device, there is a problem that image quality deterioration such as a double image and blur may occur on a 3D video image if separation between light and left images is insufficient. Leakage of a left-eye image (or right-eye image) to a right eye (or left eye) is referred to as crosstalk (ghost).

As for a liquid-crystal type, among time-sharing stereoscopic image display devices, it is desirable to alternately display right and left parallax images at the rate of approximately 120 times per second in order to perform display without generation of flicker. However, when such high-speed display is performed, the response speed of the liquid crystal becomes insufficient, and there is a problem that, since separation of right and left images becomes insufficient due to the response delay of the liquid crystal, image quality deterioration such as a double image and blur is caused on a 3D video image.

As a prior-art technique, there is proposed a method in which, in order to prevent crosstalk due to slow liquid-crystal responses of a liquid-crystal panel, gray levels of immediately previous image data and the latest image data are compared, and compensation is performed so that gradation change of the latest image data is emphasized.

However, there may be a case where intended brightness is not reached even if compensation is performed so that gradation change is emphasized. In this case, because correction is performed for the next image on the assumption that the previous image has reached a desired target value, the corrected amount is not optimum, and a desired brightness cannot be obtained. For example, in the case of a display device expressing gradation by 8 bits, the maximum gradation that image data can take is 255. Therefore, it is not possible to emphasize the gradation to be written, in change from 0 gradation to 255 gradation. Consequently, a desired brightness corresponding to the 255 gradation is not reached, and the next image is dark. At this time, since it is assumed that the desired brightness corresponding to the 255 gradation has been obtained for the previous image, the corrected amount for the next image is not optimum.

Thus, in gradation correction in consideration of only the gradation value of a previous image and the gradation value of the latest image, like the prior-art technique described above, intended prevention of occurrence of crosstalk cannot be expected.

### BRIEF DESCRIPTION OF THE DRAWINGS

FIG. 1 is a diagram illustrating the outline of a stereoscopic image display device of a first embodiment;

FIG. 2 is a block diagram showing the detailed configuration of the stereoscopic image display device;

FIG. 3 is a diagram showing the detailed configuration of a timing controlling unit;

FIG. 4 is a diagram showing the detailed configuration of a gradation level correcting unit;

FIG. 5 is a diagram showing the detailed configuration of a reached level calculating unit;

FIG. 6 is a diagram showing an example of a corrected gradation value table;

FIG. 7 is a diagram showing an example of a reached gradation value table;

FIG. 8 is a schematic diagram illustrating occurrence of crosstalk due to liquid-crystal response delay on a liquid-crystal panel;

FIG. 9 is a schematic diagram illustrating occurrence of crosstalk due to liquid-crystal response delay of liquid-crystal glasses;

FIG. 10 is a diagram showing a double image due to crosstalk;

FIG. 11 is a diagram schematically illustrating the liquid-crystal response of the liquid-crystal panel, backlight brightness, and the response of the right shutter of the glasses;

FIG. 12 is a diagram illustrating the effectiveness of performing correction using reached gradation;

FIG. 13 is a diagram showing an adjustment coefficient table showing the relationship between a lighting period and an adjustment coefficient;

FIG. 14 is a diagram showing an example of a corrected amount table for a reference lighting period;

FIG. 15 is a diagram showing examples of adjustment coefficient tables of corrected gradation value adjustment coefficients and reached gradation value adjustment coefficients corresponding to frame rates, respectively;

FIG. 16 is a diagram showing an example of a reached amount table;

FIG. 17 is a diagram showing examples of adjustment coefficient tables of corrected gradation value adjustment coefficients and reached gradation value adjustment coefficients corresponding to surface temperatures, respectively;

FIG. 18 is a diagram showing the relationship between writing of an image signal to a liquid-crystal display unit and a glasses shutter opened period and showing responses of the liquid crystal at a vertical display position;

FIG. 19 is a diagram showing the relationship between writing of an image signal to the liquid-crystal display unit and glasses shutter opened and closed periods;

FIG. 20 is a block diagram showing a stereoscopic image display device according to a second embodiment;

FIG. 21 is a diagram showing the relationship between writing of an image signal to a liquid-crystal display unit and backlight emission timing, according to the second embodiment;

FIG. 22 is a diagram showing the amount of light at a vertical display position along a time axis, according to the second embodiment;

FIG. 23 is a schematic diagram illustrating an input image and a display image in the stereoscopic image display device; and

FIG. 24 is a schematic diagram illustrating another example of a display image.

### DETAILED DESCRIPTION

According to an aspect of embodiments, there is provided a stereoscopic image display device displaying a stereoscopic image to an observer wearing glasses, the glasses controlling transmittance of light for a right eye and for a left eye.

The correction unit corrects gradation of pixels of a processing-target image signal for the right eye or for the left eye.

The image displaying unit includes a plurality of display pixels into which an image signal can be written.

The writing unit writes the image signal corrected by the correction unit into the display pixels of the image displaying unit

The reached level calculation unit calculates a reached gradation which is a gradation to be reached by each of the display pixels after one sub-frame period after the corrected image signal is written into the display pixel, on the basis of response characteristics of the display pixel, respectively.

The timing controlling unit controls opening/closing timing of the glasses according to writing timing of the writing unit.

The correction unit corrects the gradation of the pixels of the processing-target image signal, respectively, on the basis of a difference between the writing timing of the writing unit and the opening/closing timing of the glasses, and the reached gradation of the pixels in an immediately previous sub-frame.

Below, embodiments of the present invention will be described below with reference to drawings. Components or processes performing similar operations are given common reference numerals, and overlapping description will be omitted.

### First Embodiment

### Configuration of Liquid-Crystal Panel+Backlight

A stereoscopic image display device of this embodiment is a liquid-crystal display for performing stereoscopic display in a time-sharing scheme. The stereoscopic image display device switches and displays a left-eye image and a right-eye image having parallax therebetween, and alternately opens and closes the right and left shutters of special glasses so that an observer can alternately observe the right-eye images and the left-eye images. An image displayed on the stereoscopic image display device is a two-dimensional image. However, by separately displaying images having parallax between them to the right and left eyes of the observer, stereoscopic viewing utilizing binocular parallax is realized.

Time-sharing schemes include a liquid-crystal shutter glasses scheme, a polarized light filter glasses scheme, an RGB waveband division filter glasses scheme and the like. In this embodiment, a time-sharing scheme using glasses of the liquid-crystal shutter glasses scheme will be illustrated. As the time-sharing scheme, any of a field sequential scheme and a frame sequential scheme may be used. In this embodiment, the frame sequential time-sharing scheme will be described.

### (Definitions of Frame and Sub-Frame of Display Image According To Difference in Driving Method)

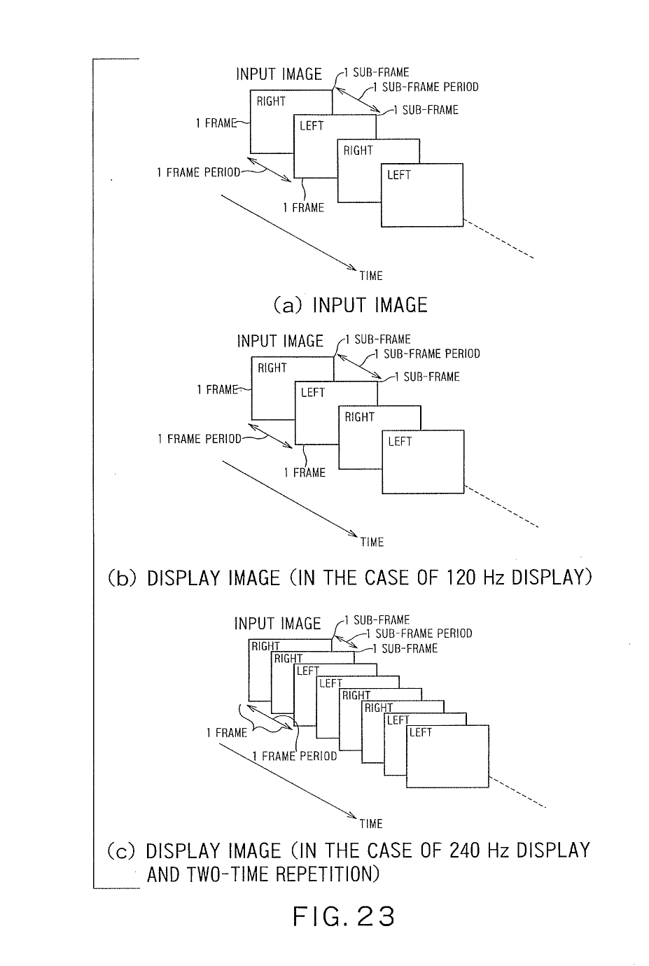

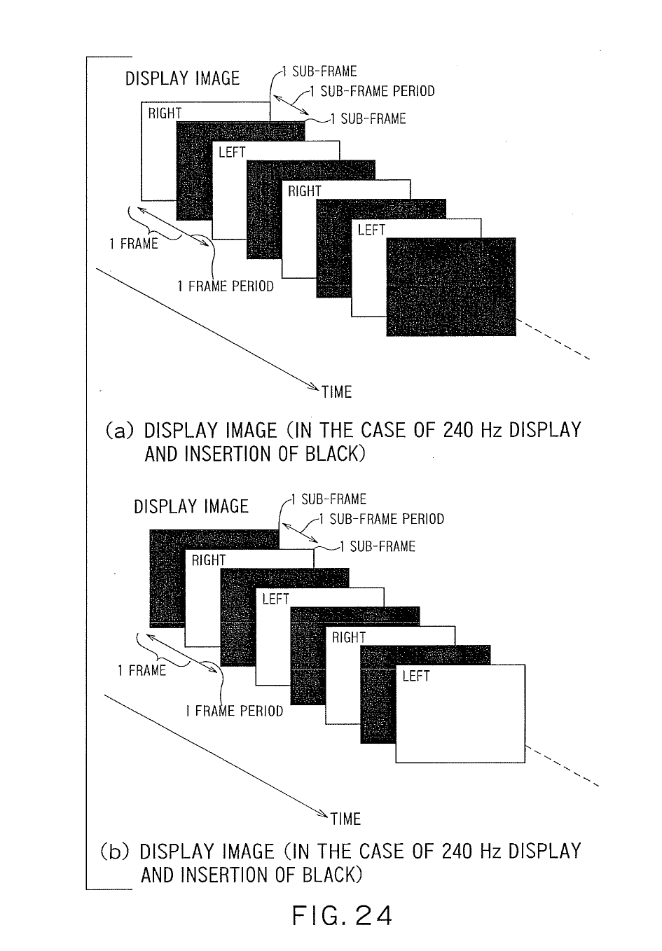

FIGS. 23 and 24 are schematic diagrams illustrating an input image and a display image in the stereoscopic image display device. FIG. 23(a) shows an example of an input image, and FIGS. 23(b), 23(c), 24(a) and 24(b) show examples of an output image. It is assumed that the unit of an image signal for a left eye (or right eye) which realizes stereoscopic viewing is 1 frame, and the unit of an image signal corresponding to one image to be displayed on a screen is 1 sub-frame. A period for displaying a frame is referred to as a frame period, and a period for displaying a sub-frame is referred to as a sub-frame period. FIG. 23(b) shows the case where an image is displayed at the frame rate of 120 Hz, and FIGS. 23(c), 24(a) and 24(b) show the case where an image is displayed at the frame rate of 240 Hz. In FIG. 23(b), one frame corresponds to one sub-frame, and a frame period corresponds to a sub-frame period. FIG. 23(c) shows a display scheme in which an image for the same viewpoint (right eye/left eye) is repeated twice (two-time repetition), and FIGS. 24(a) and 24(b) show a display scheme in which a black image is inserted between right-eye and left eye images (black insertion).

### (Description of Outline of Stereoscopic Image Display Device)

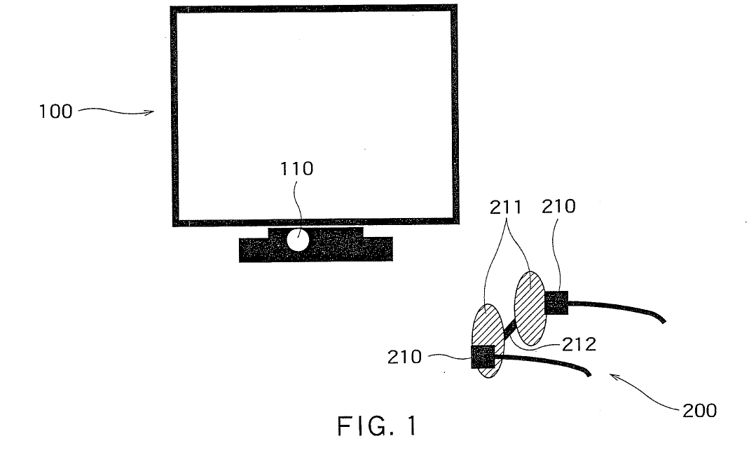

FIG. 1 is a diagram illustrating the outline of a stereoscopic image display device 100 of this embodiment.

The stereoscopic image display device 100 switches and displays a plurality of images for different viewpoints (hereinafter referred to as parallax images) by time sharing. The stereoscopic image display device 100 dispatches a switching signal for each frame by a dispatching unit 110. The dispatching unit 110 dispatches a switching signal indicating the switching timing of liquid-crystal shutters 211 to glasses 200 by infrared rays or the like. The stereoscopic image display device 100 is a liquid-crystal display provided with a backlight which radiates light from the back of the liquid-crystal panel.

The glasses 200 are provided with the right and left liquid-crystal shutters 211, a receiving unit 212 for receiving a switching signal dispatched by the dispatching unit 110, and a driving unit 210 for driving opening and closing of the right and left liquid-crystal shutters 211 in synchronization with the switching signal. The driving unit 210 controls opening and closing of the right and left liquid-crystal shutters 211 so that the lights of right-eye images and left-eye images are caused to temporally alternately enter. Thereby, parallax images provided with parallax are temporally alternately inputted to the right and left eyes of the observer. By the parallax images being alternately inputted to the right and left eyes, the observer can recognize a video image two-dimensionally displayed on the stereoscopic image display device 100 as a stereoscopic video image.

Communication between the dispatching unit 110 of the stereoscopic image display device 100 and the receiving unit 212 of the glasses 200 is not limited to communication by infrared rays. It may be communication by other wireless signals or communication by wired signals via a signal cable or the like.

### (Description of Block Diagram of Stereoscopic Image Display Device)

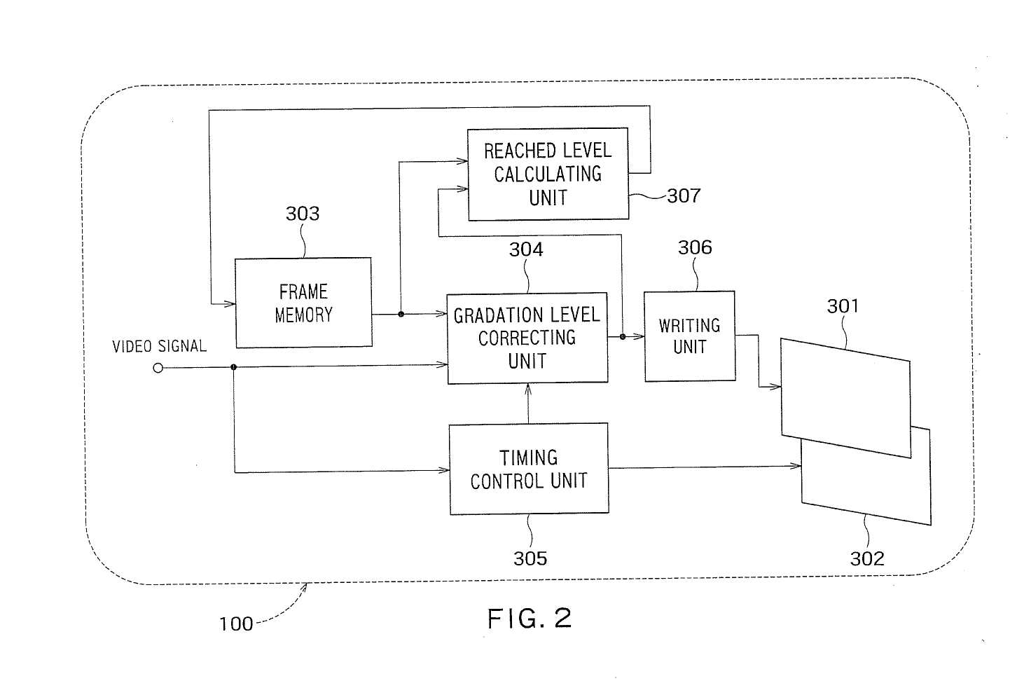

FIG. 2 is a block diagram showing the detailed configuration of the stereoscopic image display device 100. Into this device, a video signal (image signal) indicating a two-dimensional parallax image corresponding to the parallax between right and left eyes is inputted from an external device not shown (for example, a controller IC, a recording medium, a network or the like).

The stereoscopic image display device 100 is provided with a liquid-crystal display unit (liquid-crystal panel) 301, a backlight 302, a frame memory (storage unit) 303, a gradation level correcting unit (correction unit) 304, a writing unit 306, a timing controlling unit 305, and a reached level calculating unit 307.

An image signal sent from a controller IC not shown is inputted to the gradation level correcting unit 304 and the timing controlling unit 305.

The liquid-crystal display unit 301 has a plurality of liquid-crystal pixels (display pixels) into which an image signal can be written. The liquid-crystal display unit 301 receives writing of an image signal into a liquid-crystal pixel, by the writing unit 306. The liquid-crystal display unit 301 performs image display by modulating light emission from the backlight 302 according to the gradation value of the image signal written into the liquid-crystal pixel.

Lighting of the backlight 302 is controlled by the timing controlling unit 305, and the backlight 302 has a non-light emission period and a light emission period within one frame period. Light is emitted during the light emission period, and light is put out during the non-light emission period.

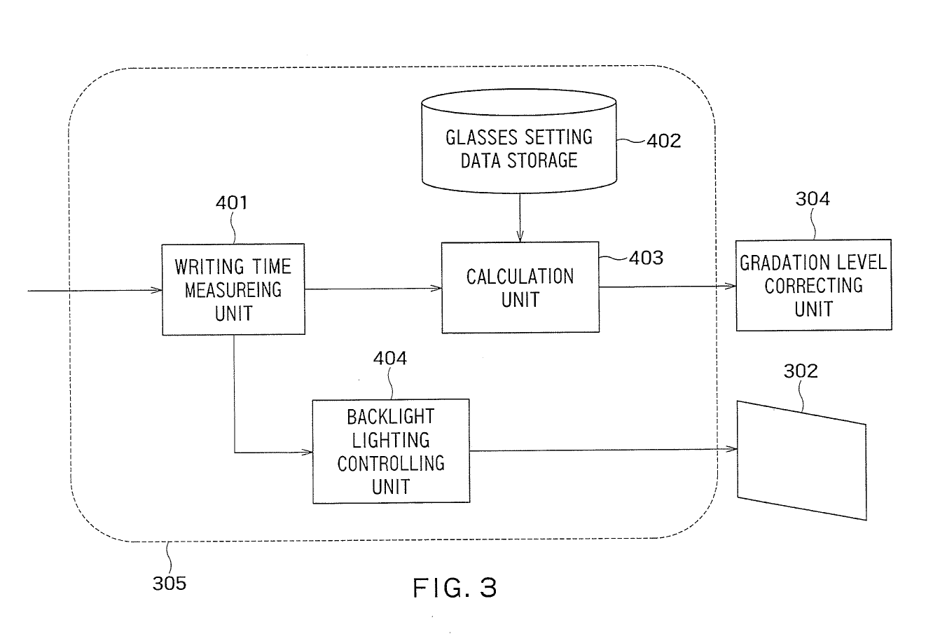

The timing controlling unit 305 controls the light emission timing of the backlight 302 and the opening/closing timing of the right and left liquid-crystal shutters of the liquid-crystal glasses according to the writing timing (writing time) of an image signal to the liquid-crystal display unit 301. The timing controlling unit 305 also calculates the time difference between the opening/closing switching timing (glasses switching time) of the right and left liquid-crystal shutters and the timing (writing time) of writing to a writing target pixel (processing-target pixel), and outputs the time difference data to the gradation level correcting unit 304. The detailed configuration of the timing controlling unit 305 will be described later with the use of FIG. 3

The frame memory 303 is a memory circuit holding a reached image signal (to be described later) corresponding to one sub-frame. It holds the reached image signal sent from the reached level calculating unit 307 for one sub-frame period and then outputs the reached image signal to the gradation level correcting unit 304 and the reached level calculating unit 307. Therefore, to the gradation level correcting unit 304, the image signal of the n-th (n: an integer equal to or larger than 2) sub-frame and the reached image signal of the (n−1)th sub-frame are inputted at the same time. To the reached level calculating unit 307, the reached image signal of the (n−1)th sub-frame and the corrected image signal of the n-th frame are inputted at the same time.

The gradation level correcting unit 304 corrects the gradation level (gradation value) of an image signal (in the n-th sub-frame) corresponding to a processing-target pixel on the basis of the image signal of the n-th sub-frame, the reached image signal of the (n−1)th sub-frame inputted from the frame memory 303, and the time difference (the time difference between the glasses switching time and the time of writing the processing-target pixel) inputted from the timing controlling unit 305. Each of the liquid-crystal pixels of the liquid-crystal display unit 301 is sequentially selected as a processing-target pixel, and gradation correction of each corresponding image signal (in the n-th sub-frame) is performed. The gradation level correcting unit 304 sends the image signal with the corrected gradation value to the writing unit 306 and the reached level calculating unit 307. The details of the gradation level correcting unit 304 will be described later.

The writing unit 306 writes the image signal with the corrected gradation value calculated by the gradation level correcting unit 304, into a corresponding liquid-crystal pixel of the liquid-crystal display unit 301.

The reached level calculating unit 307 calculates a gradation level in which the corrected image signal of the n-th sub-frame calculated by the gradation level correcting unit 304 reaches after one sub-frame period after writing into the pixel, on the basis of the reached image signal of the (n−1)th sub-frame inputted from the frame memory 303. A corrected image signal is sequentially inputted from the gradation level correcting unit 304 to each processing-target pixel, and the reached level calculating unit 307 calculates a reached gradation level for each processing-target pixel. The reached level calculating unit 307 sends a signal of the calculated gradation level (a reached image signal) to the frame memory 303, and the reached image signal is held in the frame memory 303 for one sub-frame period. The details of the reached level calculating unit 307 will be described later.

### (Detailed Description of Timing Controlling Unit)

FIG. 3 is a diagram showing the detailed configuration of the timing controlling unit 305.

The timing controlling unit 305 has a writing time measuring unit 401, a glasses setting data storage 402, a calculation unit 403, and a backlight lighting controlling unit 404.

The writing time measuring unit 401 calculates the time of a processing-target pixel being written (writing time) when the time of the top line of an image signal of one sub-frame, more specifically, the top pixel on the top line being written (hereinafter referred to as reference time) is assumed to be time 0, and outputs the calculated writing time to the calculation unit 403.

The glasses setting data storage 402 stores glasses switching time for the reference time in advance.

The calculation unit 403 reads the glasses switching time from the glasses setting data storage 402, calculates the difference between the processing-target pixel writing time from the writing time measuring unit 401 and the glasses switching time read from the glasses setting data storage 402, and outputs the calculated difference to the gradation level correcting unit 304. Naturally, the writing time is sometimes before the glasses switching time and sometimes after the glasses switching time.

The backlight lighting controlling unit 404 controls the lighting timing of the backlight 302 on the basis of the reference time. For example, the backlight lighting controlling unit 404 controls the backlight to emit light for a predetermined period after a predetermined time period after the reference time.

### (Detailed Description of Gradation Level Correcting Unit)

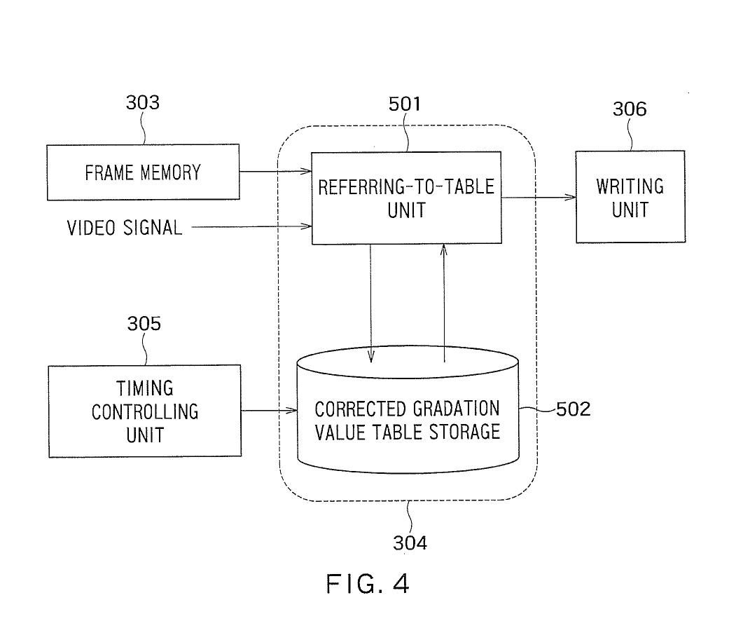

FIG. 4 is a diagram showing the detailed configuration of the gradation level correcting unit 304.

As described above, the gradation level correcting unit 304 corrects the gradation level (gradation value) of a processing-target pixel (determines a gradation level emphasizing gradation change) on the basis of the image signal of the n-th sub-frame, the reached image signal of the (n−1)th sub-frame and time difference (time difference between the writing time and the glasses switching time) outputted from the timing controlling unit 305.

Concretely, the gradation level (gradation value) of the processing-target pixel is corrected so that the difference between the total integrated intensity obtained by integrating the product of the liquid-crystal transmittance of the processing-target pixel, the backlight brightness and the transmittance of the glasses (each of the right and left liquid-crystal shutters) for one sub-frame period and perform summing up and an expected value determined in advance is minimized. The expected value determined in advance is, for example, the total integration intensity in the case where there is not liquid-crystal panel response delay, that is, in the case of a step response. The principle of such gradation correction will be described later.

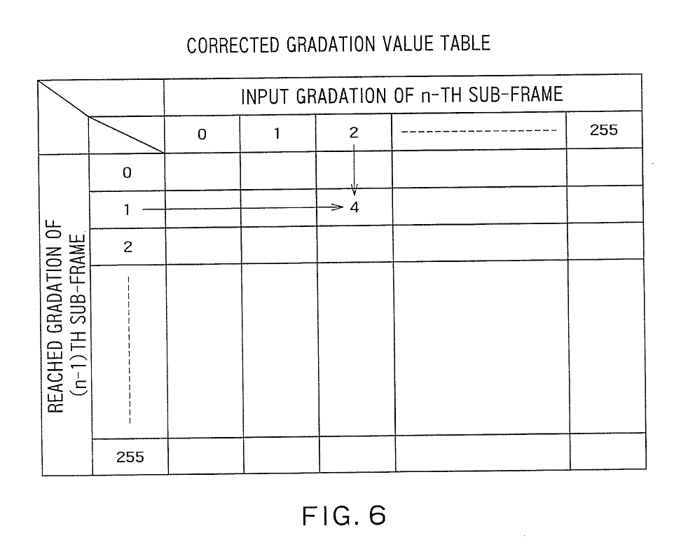

Here, it is also possible to, in order to shorten the arithmetic processing time of the gradation level correcting unit 304, create a corrected gradation value table in advance for each of a plurality of time differences (differences between writing times and glasses switching times), in which the gradation value of the n-th sub-frame, the reached gradation of the (n−1)th sub-frame and a corrected gradation value are associated, and perform the calculation on the basis of this table. FIG. 6 shows an example of the corrected gradation value table.

That is, the corrected gradation value table is stored in a corrected gradation value table storage 502 for each of the a plurality of time differences, and a referring-to-table unit 501 identifies a table corresponding to time difference inputted from the timing controlling unit 305 in the corrected gradation value table storage 502. Then, the referring-to-table unit 501 searches the identified table for a corrected gradation value corresponding to the reached gradation value of the processing-target pixel in the (n−1)th sub-frame and the gradation value of the processing-target pixel in the n-th sub-frame, and sends the image signal with the retrieved corrected gradation value to the writing unit 306. The sent image signal is written into a corresponding liquid-crystal pixel of the liquid-crystal panel 301 by the writing unit 306. The reason for using the reached gradation of the (n−1)th sub-frame to determine corrected gradation for the gradation value of the n-th sub-frame as described above is that a liquid-crystal response is not determined only by the gradation of a current sub-frame but is determined by the relationship with the reached gradation of an immediately previous sub-frame.

Such a configuration is also possible that a table in which lines and columns are thinned out at arbitrary intervals (a thinned-out table) is held as the corrected gradation value table in order to reduce the used capacity of the corrected gradation value table storage 502, and, if there is not a place to be referred to in the thinned-out table, interpolation from surrounding table values is performed to determine a corrected gradation value.

Such a configuration is also possible that a table is not held for each time difference but a reference time difference table (a reference table) is held in order to reduce the used capacity of the corrected gradation value table storage 502, and the table values of the reference table are adjusted according to time difference to determine a corrected gradation value.

### (Detailed Description of Reached Level Calculating Unit)

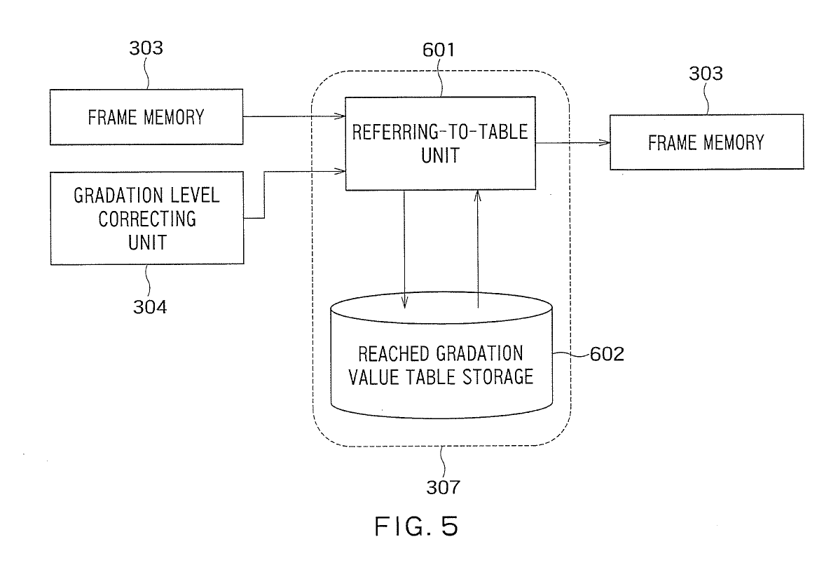

FIG. 5 is a diagram showing the detailed configuration of the reached level calculating unit 307.

As described above, on the basis of the reached image signal of the (n−1)th sub-frame and the corrected image signal of the n-th sub-frame, the reached level calculating unit 307 calculates a gradation level (gradation value) reached after one sub-frame period after writing of the corrected image signal into a processing-target pixel. Since the timing of writing into each pixel on the liquid-crystal panel 301 differs a little according to the position of the pixel, the starting point of one sub-frame at the time of determining a reached gradation level also differs a little for each pixel.

Concretely, response waveform data at the time of writing the corrected gradation value of the n-th sub-frame is measured in advance, with the reached gradation of a processing-target pixel after the end of the (n−1)th sub-frame as the start, and the gradation at the time after one sub-frame period after the start of the response waveform data is caused to be the reached gradation. The reached gradation may be calculated with the use of the approximate expression of Formula 1 without using the measured data. Formula 1 is an approximate expression of a general liquid-crystal time response, in which T₀ denotes the reached gradation of a previous sub-frame, T₁ denotes gradation to be written, and t denotes time required until the response reaches 90% when the response starting level is 0% and the target level is 100%.

$$T ( t ) = ( {T}_{1} - {T}_{0} ) [ 1 - exp ( \frac{- ln 10}{τ} t ) ] + {T}_{0} \qquad [ formula 1 ]$$

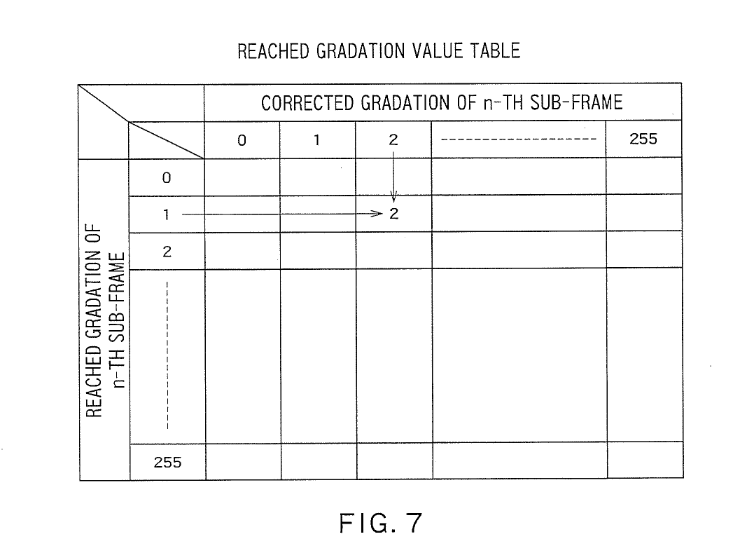

Here, it is also possible to, in order to shorten the arithmetic processing time of the reached level calculating unit 307, create a reached gradation value table in advance in which the reached gradation value of the (n−1)th sub-frame, the corrected gradation value of the n-th sub-frame and a reached gradation value are associated, and perform the calculation on the basis of this table. FIG. 7 shows an example of the reached gradation value table.

That is, the reached gradation value table is stored in a reached gradation value table storage 602, and a referring-to-table unit 601 searches for a reached gradation value corresponding to the reached gradation value of a processing-target pixel in the (n−1)th sub-frame and the corrected gradation value of the processing-target pixel in the n-th sub-frame, and writes an image signal with the retrieved reached gradation value into the frame memory 303. The reason for using the corrected gradation value of the n-th sub-frame and the reached gradation of the (n−1)th sub-frame as described above is that an actual liquid-crystal response is not determined only by the corrected gradation of a current sub-frame but is determined by the relationship with the reached gradation of an immediately previous sub-frame.

Such a configuration is also possible that a table in which lines and columns are thinned out at arbitrary intervals (a thinned-out table) is held as the reached gradation value table in order to reduce the used capacity of the reached gradation value table storage 602 and, if there is not a place to be referred to in the thinned-out table, interpolation from surrounding table values is performed to determine reached gradation.

### (Mechanism of Occurrence of Crosstalk Due to Liquid-Crystal Response Delay)

The principle of gradation correction performed by the gradation level correcting unit 304 will be described below.

First, the principle of occurrence of crosstalk will be described.

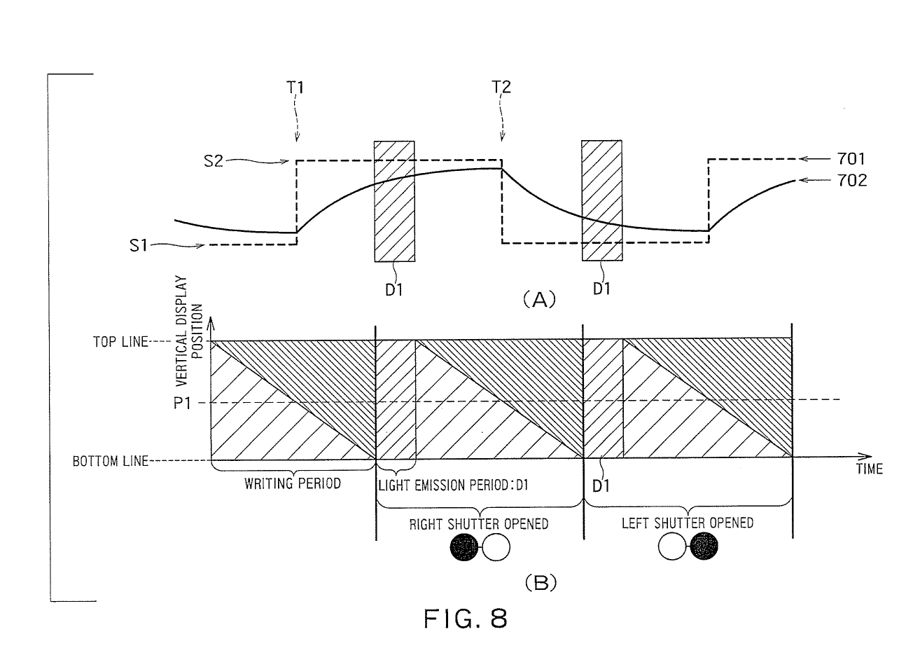

FIG. 8 is a schematic diagram illustrating occurrence of crosstalk due to liquid-crystal response delay in the liquid-crystal panel 301. More specifically, FIG. 8(B) shows the relationship among a period of writing to the liquid-crystal panel, a backlight emission period and a shutter opened period. FIG. 8(A) shows liquid-crystal responses at a vertical display position P1 of the liquid-crystal panel shown in FIG. 8(B).

In FIG. 8(B), a backlight emission period D1 is assumed to be from the time of writing of the bottom line of the liquid-crystal panel to the time of writing of the top line of the next frame. The liquid-crystal glasses shutter opened period is assumed to be from backlight emission start time to the next emission start time. Time required from writing to backlight emission differs for each vertical display position, more specifically, for each pixel. Concretely, the time required from writing to light emission is shorter as the vertical display position is lower.

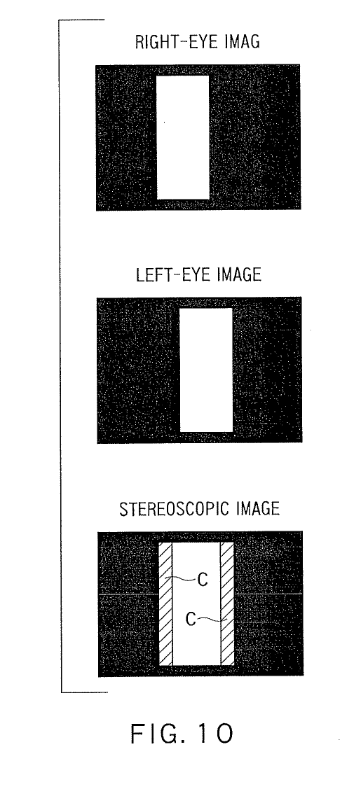

FIG. 8(A) shows liquid-crystal responses in the case where two gradations S1 and S2 are alternately written. A response 701 is an ideal liquid-crystal response (step response). When writing is started, this ideal response 701 changes to a desired target value without delay. For example, when writing is started at time T1, the response 701 changes to the target value S2 without delay. When writing is started at time T2, the response 701 changes to the target value S1 without delay. However, since the actual response is a response 702 which includes delay, backlight is emitted before the liquid-crystal response is completed at the vertical display position P1 (in the response 702, the liquid-crystal response is completed without reaching a target value). Therefore, in the case of a display image shown in FIG. 10 in which a 200-gradation box appears to project out from a 20-gradation background, the observer perceives double images C due to crosstalk on the right and left sides of the box.

### (Mechanism of Occurrence of Crosstalk Due to Glasses Response Delay)

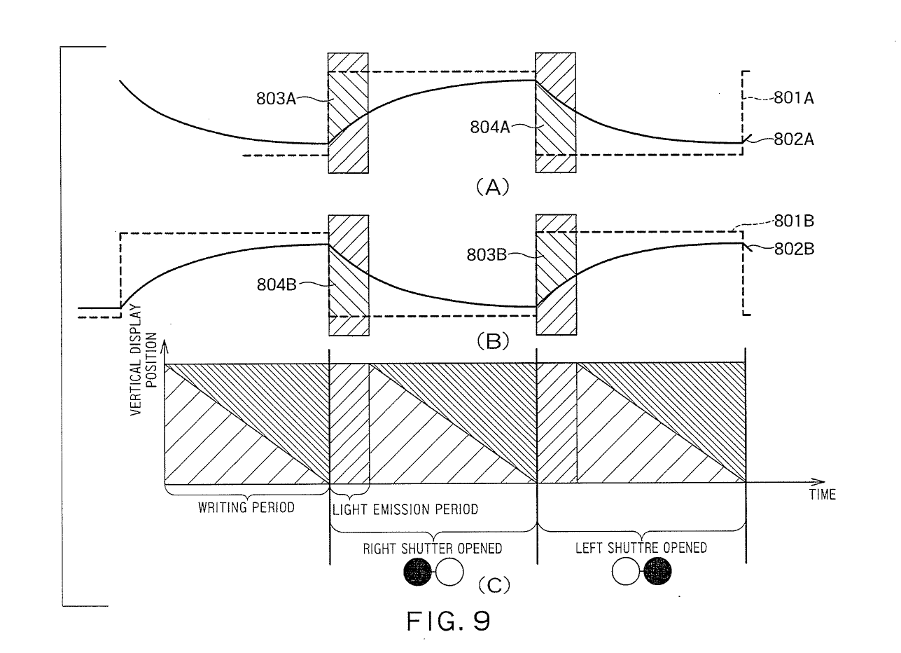

FIG. 9 is a schematic diagram illustrating occurrence of crosstalk due to liquid-crystal response delay of the liquid-crystal glasses.

FIG. 9(A) shows responses of the right shutter of the liquid-crystal glasses, and FIG. 9(B) shows responses of the left shutter of the liquid-crystal glasses. FIG. 9(C) shows the relationship among the period of writing to the liquid-crystal panel, the backlight emission period, and the shutter opened period (the same diagram as FIG. 8(B)).

As shown in FIG. 9(C), opening of the right shutter and opening of the left shutter are alternately repeated, and the right and left shutters are not closed at the same time.

In FIGS. 9(A) and 9(B), responses 801A and 801B are ideal responses (step responses) of the shutters of the glasses, and opening and closing are performed at the opening/closing switching timing without delay. However, since the actual responses are responses 802A and 802B which include delay, brightness decrease due to the amounts of shortage 803A or 803B may occur when the shutter is opened, and crosstalk due to the amounts of excess 804A or 804B may occur when the shutter is closed. Therefore, similarly to the case of liquid-crystal response delay of the liquid-crystal panel, the double images due to crosstalk shown in FIG. 10 are perceived.

In order to solve the problem shown in FIGS. 8 and 9, liquid-crystal material with a high response speed can be used for both the liquid-crystal panel and the liquid-crystal glasses. However, since such liquid-crystal material is in a development stage and is expensive, it is difficult to use it for products. Furthermore, even in the case of taking measures, such as shortening the scan time or shortening the light emission period, there are problems such as increase in circuit load and decrease in display brightness. Therefore, in this embodiment, this problem is solved by the above-stated gradation correction process by the gradation level correcting unit 304. The principle of this gradation correction process will be described below.

### (Corrected Gradation Value Setting Method)

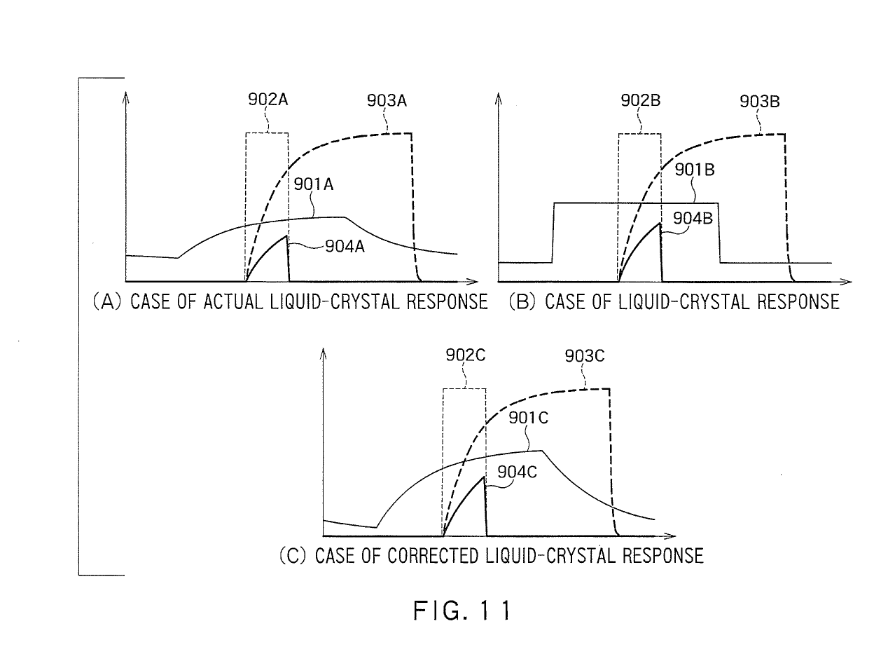

FIG. 11 is a diagram schematically illustrating the liquid-crystal response of the liquid-crystal panel, backlight brightness, and the response of the right shutter of the glasses (at the time of opening) at a vertical display position P1 shown in FIG. 8(B).

FIG. 11(A) shows a response in the case of performing display on the liquid-crystal panel without correcting the gradation of an input image signal. FIG. 11(B) shows a response which reaches a target value without liquid-crystal response delay (that is, a step response which is an ideal response). FIG. 11(C) shows a response in the case of performing display on the liquid-crystal panel with corrected gradation calculated by the gradation level correcting unit 304.

In FIG. 11(A), 901A denotes a liquid-crystal response (without gradation correction); 902A denotes backlight brightness; 903A denotes a shutter response of the glasses; 904A denotes the product of the liquid-crystal response 901A, the backlight 902A, and the shutter response 903A of the glasses. Energy (integrated intensity, which is the integral value of the product) corresponding to the area surrounded by the response 904A is actually inputted into the eyes of the observer.

In FIG. 11(B), though backlight brightness 902B and a shutter response 903B of the glasses are the same as FIG. 11(A), a liquid-crystal response 901B is an ideal response without delay. Reference numeral 904B denotes the product of the liquid-crystal response 901B, the backlight 902B, and the shutter response 903B of the glasses. Energy (integrated intensity) corresponding to the area surrounded by the response 904B is larger than the area (integrated intensity) of the response 904A in FIG. 11(A).

In FIGS. 11(A) and 11(B), the relationship corresponding to a right shutter opened period is shown. A left shutter closing response occurs at the same time when the opening of the right shutter occurs. Therefore, energy (integrated intensity) corresponding to integration of the product of the shutter closing response, the liquid-crystal response 901A, and the backlight 902A is also inputted into the eyes of the observer.

In this embodiment, gradation correction of an image signal is performed so that integrated intensity obtained in the case of correcting the gradation (total integrated intensity of integrated intensity corresponding to the right-eye shutter and integrated intensity corresponding to the left-eye shutter) is as close to the integrated intensity in the ideal case in FIG. 11(B) (total integrated intensity of integrated intensity corresponding to the right-eye shutter and integrated intensity corresponding to the left-eye shutter) as possible. For example, the gradation of an image signal is corrected so that the difference between the total integrated intensity in the case of having performed correction and the total integrated intensity in the ideal case in FIG. 11(B) is minimized, or equal to or below a threshold.

A response 901C in FIG. 11(C) denotes a liquid-crystal response in the case of having performed the gradation correction of this embodiment, and a response 904C denotes integrated intensity (corresponding to the right-eye shutter) on the basis of the gradation correction. Backlight brightness 902C and a right shutter response 903C of the glasses are the same as FIGS. 11(A) and 11(B). Due to the gradation correction of this embodiment, the difference between the total integrated intensity in the case of having performed correction and the total integrated intensity in the ideal case (an expected value) is equal to or below a threshold. Thereby, it is possible to cause the observer wearing the liquid-crystal glasses to visually confirm a high-quality stereoscopic image for which occurrence of crosstalk is significantly suppressed.

On the basis of the principle as described above, the gradation level correcting unit 304 performs gradation correction. That is, the gradation value of an image to be written and the reached gradation value of the image of the previous sub-frame stored in the frame memory 303 are compared for each pixel to determine gradation change, and the gradation value of the image of the n-th frame is corrected according to the difference between the glasses switching time and the writing time, on the basis of the gradation change.

Concretely, the corrected gradation value is calculated so that the difference between integrated intensity obtained by integrating and summing up the product of the liquid-crystal transmittance of a processing-target pixel, the backlight brightness, and the transmittance of the glasses (each of the right and left liquid-crystal shutters), and an expected value determined in advance is minimized. The backlight lighting period, the backlight brightness, the liquid-crystal writing period, the glasses shutter opened period, and each of the right and left shutter responses of the glasses are determined in advance. The liquid-crystal response of the liquid-crystal panel can be calculated, for example, from the reached gradation of an immediately previous sub-frame, the input gradation of the next frame, and the liquid-crystal writing period. From this, it is possible to calculate such corrected gradation that the difference from an expected value is minimized, or equal to or below a threshold, according to the above time difference and the combination of the reached gradation value of the (n−1)th sub-frame and the input gradation value of the n-th sub-frame. In the case of applying the embodiment of the present invention to a device of a type other than a liquid-crystal display, the display brightness of the display panel can be used instead of the product of the liquid-crystal transmittance and the backlight brightness.

It is also possible to, in order to reduce the amount of calculation, use a table (see FIG. 6) as described above. In this case, a corrected gradation value is calculated in advance for each pair of the reached gradation of the (n−1)the sub-frame and the input gradation value of the n-th sub-frame, for each difference (time difference) between glasses switching time and writing time, and the corrected gradation values are stored in the corrected gradation value table storage 502 in the form of a table. Then, a table corresponding to time difference notified from the timing controlling unit 305 is identified, and corrected gradation corresponding to the pair of the reached gradation value of the (n−1)th sub-frame and the input gradation value of the n-th frame is obtained from the table.

### (Merit of Using Reached Gradation Value)

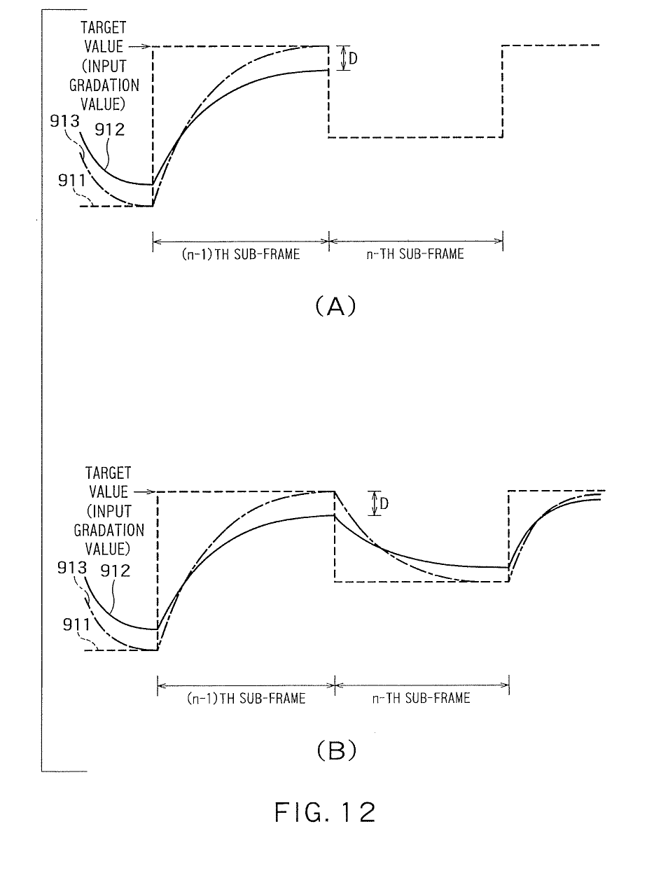

Next, the merit of performing correction using reached gradation will be described. Each of FIGS. 12(A) and 12(B) is a diagram showing liquid-crystal panel responses in the (n−1)th sub-frame and the n-th sub-frame. Concretely, a response 911 is an ideal response (step response), and responses 912 and 913 are liquid-crystal responses corrected under different conditions.

Under a condition (i) in which the response 913 becomes a corrected response, the gradation value reaches a target value after one sub-frame period. Under a condition (ii) in which the response 912 becomes a corrected response, the gradation value does not reach the target value after one sub-frame period.

In the case of correcting the gradation value of the n-th sub-frame under these two conditions, since the initial value of the n-th sub-frame corresponds to the input gradation value of the (n−1)th sub-frame under the condition (i), an actual response in the n-th sub-frame is determined with the use of the input gradation value of the (n−1)th sub-frame and the input gradation value of the n-th sub-frame. Therefore, a corrected response in the n-th sub-frame is determined, and corrected gradation can be determined.

Under the condition (ii), however, the initial value of the n-th sub-frame does not correspond to the input gradation value of the (n−1)th sub-frame, and therefore, the n-th sub-frame cannot be optimally corrected by the correction method using the input gradation values of the (n−1)th sub-frame and the n-th sub-frame. That is, the corrected amount is not optimized because of an error D shown in the figure.

Thus, in the first embodiment, reached gradation (that is, gradation in consideration of the error D for the input gradation) for the (n−1)the sub-frame is determined, and the input gradation of the n-th sub-frame is corrected on the assumption that the gradation value at the time of starting writing into a pixel in the n-th sub-frame is this reached gradation. Thus, the corrected amount can be optimally set.

### (Adjustment of the Corrected Amount According to the Backlight Lighting Period)

When the backlight lighting period changes, the backlight response changes. Therefore, the corrected gradation value must be newly calculated. Therefore, tables corresponding not only to time differences but also to lighting periods are stored in the corrected gradation value table storage 502, and the table to be used is switched on the basis of time difference and lighting period information outputted from the timing controlling unit 305 to determine the corrected gradation value. Such a configuration is also possible that the backlight lighting period information is outputted from an external controller not shown in FIG. 2.

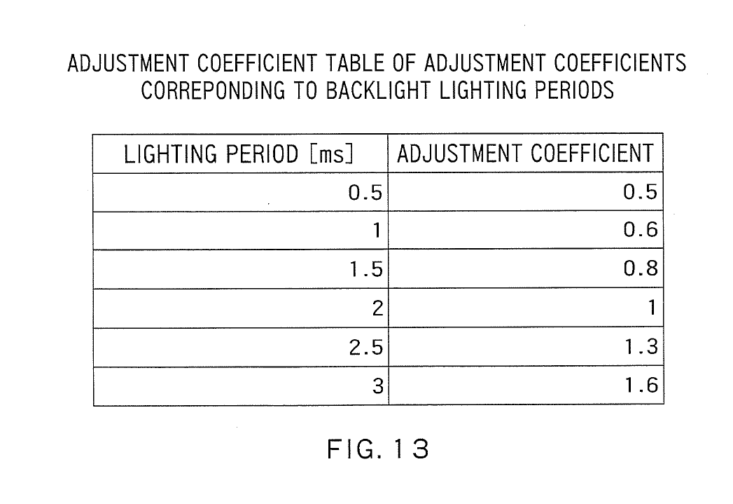

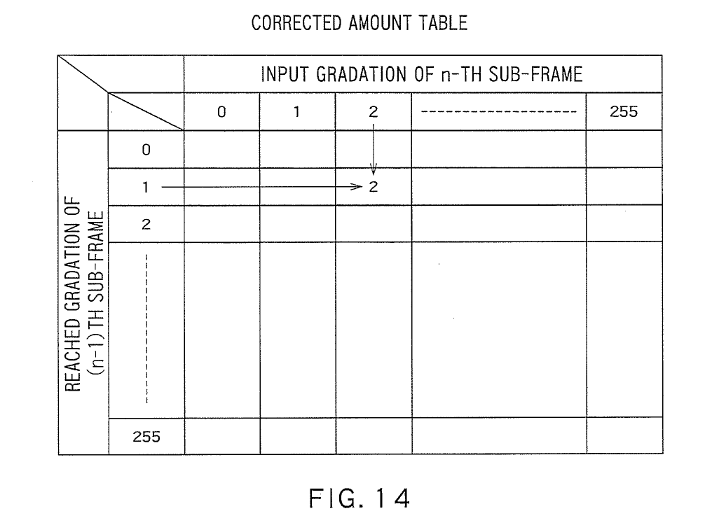

In order to reduce the used storage capacity of the corrected gradation value table storage 502, the following configuration may be adopted. That is, a corrected amount table (a reference table), with differences between corrected gradation values and input gradations (corrected amounts) as table values, is created for each time difference with a certain lighting period as a reference. The corrected amount for other lighting periods is determined by multiplying the table values of an appropriate reference table by an adjustment coefficient the value of which is larger as the lighting period is longer. A corrected gradation value is obtained by adding the input gradation value of the n-th sub-frame to the determined corrected amount. FIG. 13 shows an example of an adjustment coefficient table showing the relationship between the lighting period and the adjustment coefficient, and FIG. 14 shows an example of the corrected amount table for a reference lighting period (the corrected amount table as shown in FIG. 14 exists for each time difference).

For example, it is assumed that the lighting period is 1.5 ms and a corrected amount table to be used is the corrected amount table shown in FIG. 14. It is also assumed that the reached gradation of the (n−1)th sub-frame is 1, and the input gradation of the n-th sub-frame is 2. In this case, since the adjustment coefficient is 0.8 from FIG. 13, and the appropriate table value of the corrected amount table in FIG. 14 is 2, the corrected amount is 2×0.8=1.6. Therefore, the corrected gradation value is 2+1.6=3.6.

### (Adjustment of the Corrected Amount and the Reached Amount According to Frame Rate)

When the frame rate (refresh rate) of the liquid-crystal display unit 301 changes, the response of the liquid-crystal panel, the backlight response, and the glasses response change; and so the corrected gradation value must be newly calculated. Therefore, a table is stored in the corrected gradation value table storage 502 for each frame rate and each time difference, and the table to be used is switched on the basis of frame rate information and time difference outputted from the timing controlling unit 305 to determine the corrected gradation value.

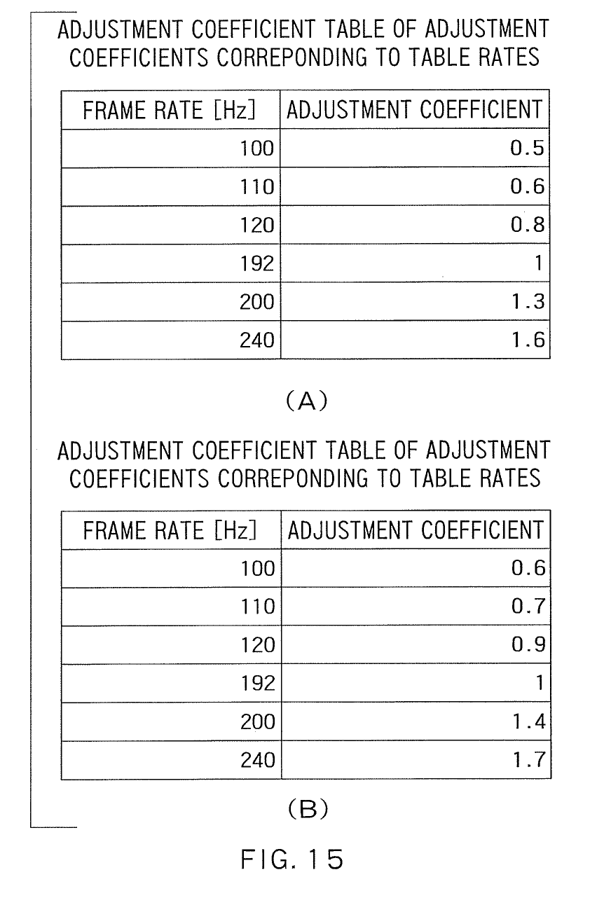

In order to reduce the used storage capacity of the corrected gradation value table storage 502, the following configuration may be adopted. Similarly to the case of changing the backlight lighting period, a corrected amount table (reference table) for a certain frame rate is prepared for each time difference, and the corrected amount for other frame rates is determined by multiplication by an adjustment coefficient the value of which is larger as the frame rate is higher. FIG. 15(A) shows an example of an adjustment coefficient table of adjustment coefficients corresponding to frame rates. A corrected gradation value can be obtained by adding the input gradation value of the n-th sub-frame to the determined corrected amount.

When the frame rate of the liquid-crystal display unit 301 changes, the response of the liquid-crystal panel changes; and so the reached gradation value must be newly calculated. Therefore, a table is stored in the reached gradation value table storage 602 for each frame rate, and the table to be used is switched on the basis of frame rate information outputted from the timing controlling unit 305 to determine the reached gradation value. Such a configuration is also possible that the frame rate information is outputted from the external controller not shown in FIG. 2.

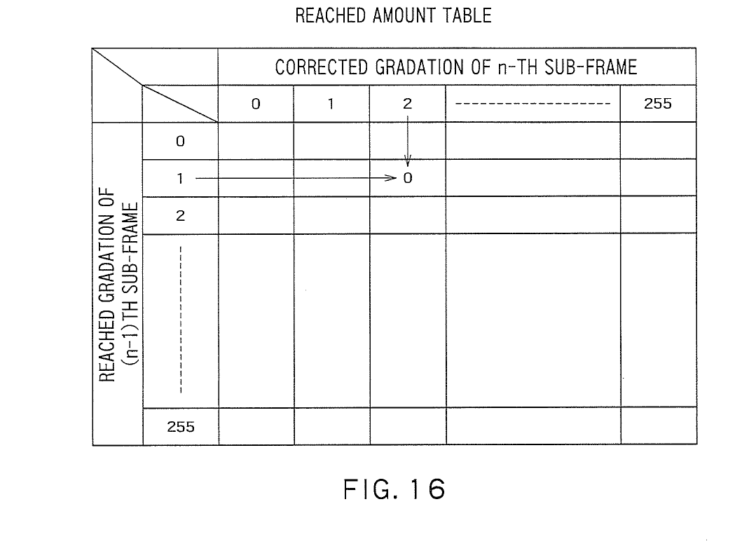

Similarly to the adjustment coefficient table for corrected gradation value (FIG. 15(A)), it is also possible to create an adjustment coefficient table for reached gradation value as shown in FIG. 15(B) and determine a reached gradation value using an adjustment coefficient the value of which is larger as the frame rate is higher. In this case, instead of a reached gradation value table, a reached amount table is created in which differences between reached gradation values and corrected gradation values (reached amounts) are used as table values. FIG. 16 shows an example of the reached amount table. The reached gradation value can be obtained by multiplying a reached amount identified from the reached amount table in FIG. 16 on the basis of the reached gradation of the (n−1)th sub-frame and the corrected gradation of the n-th sub-frame, by an adjustment coefficient corresponding to the frame rate, and adding the multiplied value to the corrected gradation of the n-th sub-frame.

In the description above, it is assumed that the frame rate corresponds to the sub-frame rate. When these are different from each other, the above description can be read, with “frame rate” in the description replaced with “sub-frame rate”. Similarly, FIG. 15 can be read, with “frame rate” replaced with “sub-frame rate”.

### (Adjustment of the Corrected Amount and the Reached Amount According to Temperature)

When the surface temperature of the liquid-crystal display unit 301 changes, the liquid-crystal response speed changes (the speed is slower as the temperature is lower), and thereby, the liquid-crystal panel response changes (for example, the value of τ in formula 1 changes). Therefore, the corrected gradation value must be newly calculated according to change in the surface temperature of the liquid-crystal display unit 301. Therefore, a table is stored in the corrected gradation value table storage 502 for each surface temperature and each time difference, and the table is switched on the basis of surface temperature information and time difference outputted from the external controller not shown in FIG. 2 to determine the corrected gradation value. The surface temperature information can be acquired from a temperature sensor attached to the liquid-crystal display unit or temperature characteristics for time elapsed after power is on.

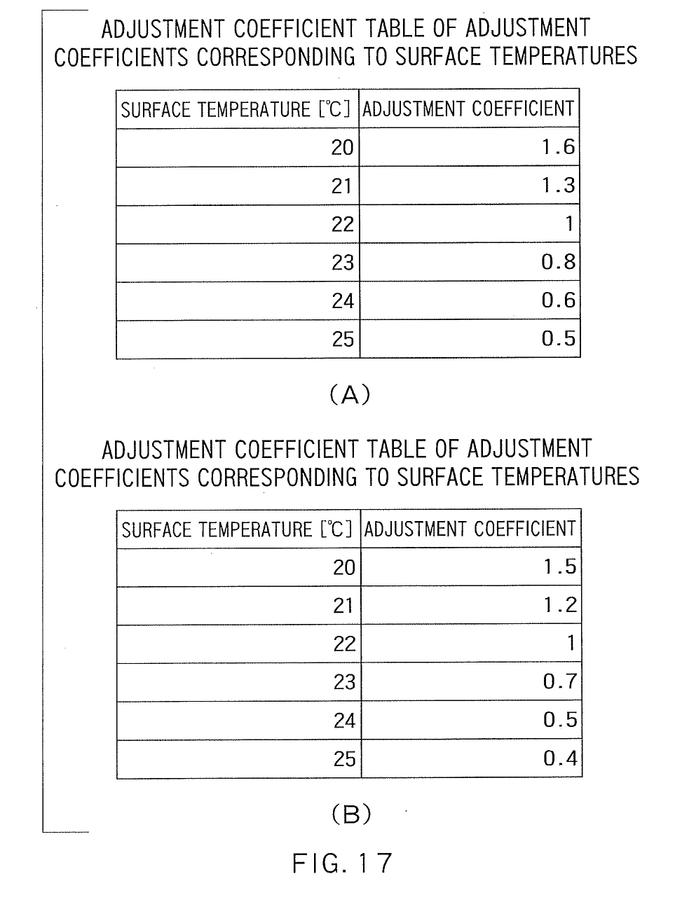

In order to reduce the used storage capacity of the corrected gradation value table storage 502, the following configuration may be adopted. Similarly to the case of changing the backlight lighting period, a corrected amount table for certain surface temperature is prepared as a reference, and the corrected amount for other surface temperatures is determined by multiplying a reference corrected amount by an adjustment coefficient the value of which is smaller as the surface temperature is higher. FIG. 17(A) shows an example of an adjustment coefficient table of adjustment coefficients corresponding surface temperatures. A corrected gradation value can be obtained by adding the input gradation value of the n-th sub-frame to the determined corrected amount.

When the surface temperature of the liquid-crystal display unit 301 changes, the reached gradation value must be newly calculated. Therefore, a table is stored in the reached gradation value table storage 602 for each surface temperature, and the table is switched on the basis of surface temperature information outputted from the external controller not shown in FIG. 2 to determine the reached gradation value.

Similarly to the adjustment coefficient table for corrected gradation value (see FIG. 17(A)), it is also possible to create an adjustment coefficient table for reached gradation value as shown in FIG. 17(B) and determine a reached gradation value by multiplication by an adjustment coefficient the value of which is smaller as the surface temperature is higher. In this case, a reached amount table (see FIG. 16) is held instead of a reached gradation value table. The reached gradation value can be obtained by multiplying a reached amount identified from the reached amount table on the basis of the reached gradation of the (n−1)th sub-frame and the corrected gradation of the n-th sub-frame by an adjustment coefficient corresponding to the surface temperature and adding the multiplied value to the corrected gradation of the n-th sub-frame.

### (Adjustment of the Corrected Amount According to User Input Information)

When the observer adjusts the image quality with an input device such as a remote controller, for example, when the observer changes the brightness, the backlight response (for example, the light emission period) changes; and so the corrected gradation value must be newly calculated. Therefore, a table is stored in the corrected gradation value table storage 502 for each user input information, and the table is switched on the basis of user input information outputted from the external controller not shown in FIG. 2 to determine the corrected gradation value.

Here, such a configuration is also possible that, in order to reduce the used storage capacity of the corrected gradation value table storage 502, an adjustment coefficient table in which user input information and an adjustment coefficient are associated with each other is stored similarly to the case of changing the backlight lighting period.

### (Stabilization of Corrected Gradation Value)

A configuration is also possible that, if the absolute value of the difference between the reached gradation of the (n−1)th sub-frame and the input gradation of the n-th sub-frame is equal to or below a certain threshold, the gradation level correcting unit 304 sets the input gradation of the n-th sub-frame as the corrected gradation of the n-th sub-frame. Thereby, advantages of preventing emphasis of noise in the case where an input video image includes a lot of noise and reducing an emphasized gradation error caused by a reached gradation calculation error.

A configuration is also possible that, if the absolute value of the difference between the reached gradation of the (n−1)th sub-frame and the corrected gradation of the n-th sub-frame is equal to or below a certain threshold, the reached level calculating unit 307 sets the reached gradation of the (n−1)th sub-frame as the reached gradation of the n-th sub-frame. Thereby, it is possible to reduce the influence of the noise and error described above.

A configuration is also possible that, the gradation level correcting unit 304 outputs the input gradation together with the corrected gradation of the n-th sub-frame, and, if the absolute value of the difference between the reached gradation of the (n−1)th sub-frame and the input gradation of the n-th sub-frame is equal to or below a certain threshold, the reached level calculating unit 307 sets the input gradation of the n-th sub-frame as the reached gradation of the n-th sub-frame. Thereby, it is possible to reduce the influence of the noise and error described above.

Each of the certain thresholds stated here is not required to be the same value, and an appropriately determined value can be used according to the processing purpose and nature of each threshold.

In this embodiment described above, the image displaying unit is constituted by a liquid-crystal display unit and a backlight. However, since crosstalk can be prevented in a similar way of thinking for such an image displaying unit that insufficient separation of right and left images is caused by occurrence of delay in image display, this embodiment is applicable to display units other than the liquid-crystal type.

The stereoscopic image display device 100 in this embodiment can be used to display a 2D image. In this case, the processing by the gradation level correcting unit 304 is bypassed, and an image signal is outputted directly to the liquid-crystal display unit 301 via the writing unit 306. The timing controlling unit 305 measures the writing time of the input image signal and executes only the processing for controlling lighting of the backlight 302.

Thus, according to this embodiment, it is possible to cause an observer wearing liquid-crystal glasses to visually confirm a high-quality stereoscopic image for which occurrence of crosstalk is significantly suppressed.

In the prior-art technique stated in the paragraphs of BACKGROUND, gradation correction is performed in consideration of only backlight brightness and liquid-crystal transmittance, and intended prevention of occurrence of crosstalk cannot be expected. That is, in the case of a glasses-type time-sharing stereoscopic image display device, delay occurs in a response at the time displaying an image, which not only causes insufficient separation between the right and the left but also causes response delay in opening/closing of glasses. Therefore, crosstalk occurs, and the image quality of a stereoscopic video image is significantly influenced. Furthermore, the delay in opening/closing of the glasses may cause occurrence of uneven brightness and brightness deterioration. In the case of a liquid-crystal type, among glasses-type time-sharing stereoscopic image display devices, not only delay in the liquid-crystal response of the panel but also liquid-crystal response delay in opening/closing of the liquid-crystal shutter glasses is caused, which becomes a factor of crosstalk, and significantly influences the image quality of a stereoscopic video image. Furthermore, the delay in opening/closing of the glasses may cause occurrence of uneven brightness and brightness deterioration.

However, the response of the glasses is not considered at all, and the reached level of the response is also not considered, as described above. Therefore, occurrence of crosstalk cannot be sufficiently suppressed.

In this embodiment, however, gradation correction is performed in consideration of both of the response of glasses and the reached level of the response. Thereby, it is possible to cause a high-quality stereoscopic image for which occurrence of crosstalk is significantly suppressed to be visually confirmed.

(First Variation of the First Embodiment: in the Case where the Backlight is Always Lit)

In the first embodiment, an example has been described in which the non-light emission period and light emission period of the backlight are switched within one frame period. In this first variation, an example will be described in which the backlight is always lit, and a black image is inserted between a right-eye image and a left-eye image.

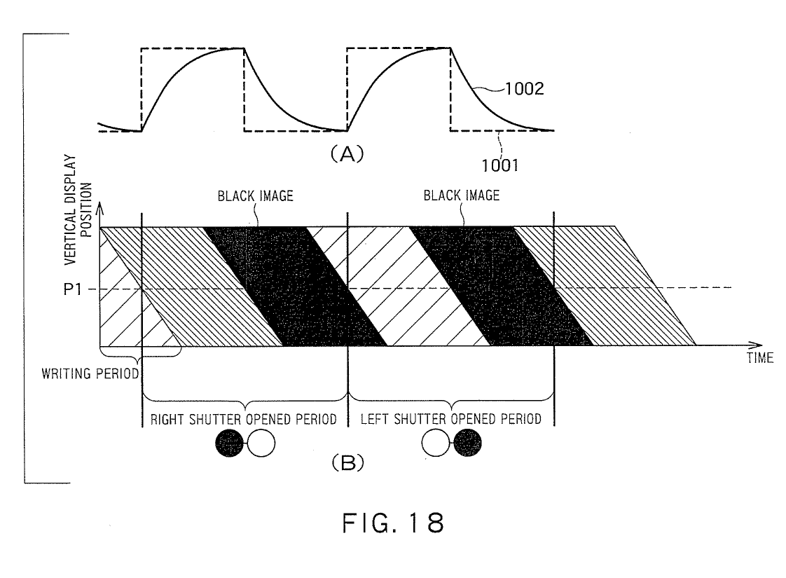

FIG. 18(B) is a time chart showing the relationship between writing of an image signal to the liquid-crystal display unit 301 and the glasses shutter opened period. FIG. 18(A) shows a liquid-crystal response at a vertical display position P1. The broken line in FIG. 18(A) indicates an ideal response 1001, and the solid line indicates an actual response (a response with delay) 1002. In this example, the backlight is always lit.

Description will be made on the case where the glasses shutter switching timing is set to correspond to the writing timing of a left-eye or right-eye image signal at the vertical display position P1. By inserting black images as shown in the figure, crosstalk does not occur at the vertical display position P1. However, at other vertical display positions, crosstalk may occur because the video image writing timing and the glasses shutter switching timing does not correspond to each other. Therefore, in the first variation also, it is possible to prevent crosstalk by performing correction similar to the first embodiment.

(Second Variation of the First Embodiment: in the Case where the Glasses Opened Period is Set Short)

As a second variation example of the first embodiment, an example will be described in which the backlight is always lit, and there exists a period during which the right and left shutters of the glasses are closed at the same time.

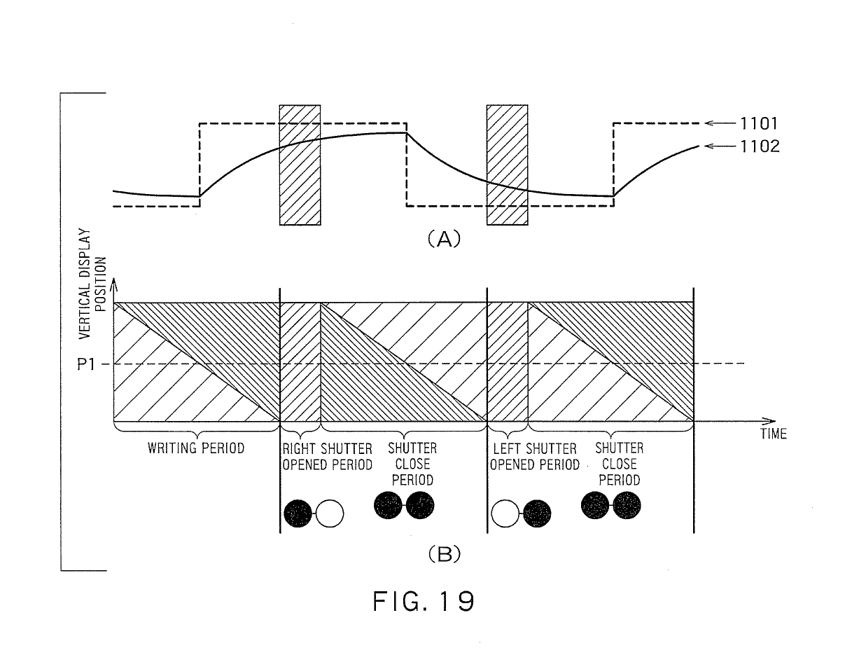

FIG. 19 is a time chart showing the relationship between writing of an image signal to the liquid-crystal display unit 301 and the glasses shutter opened and closed periods. In this example, the backlight is always lit.

In this case also, similarly to the first embodiment, delay occurs in the liquid-crystal response, and therefore, the glasses shutter may open before the liquid-crystal response is completed, which will cause crosstalk. Delay also occurs in the glasses shutter response, which will also causes crosstalk. Therefore, in the second variation also, it is possible to prevent crosstalk by performing correction similar to the first embodiment.

In the second variation, the case where the backlight is always lit has been described. However, the non-light emission period and light emission period of the backlight may be switched. In this case, by putting out the backlight during the period when both the right and left glasses shutters are closed, it is possible to reduce power consumption without reducing the screen brightness.

### Second Embodiment

In this embodiment, description will be made on the case where a structure in which a plurality of horizontal emission units are adjacently arranged along the vertical direction of the screen is used as the structure of the backlight, and a scan backlight method is adopted in which lighting of the emission units is sequentially switched during one frame period or one sub-frame period.

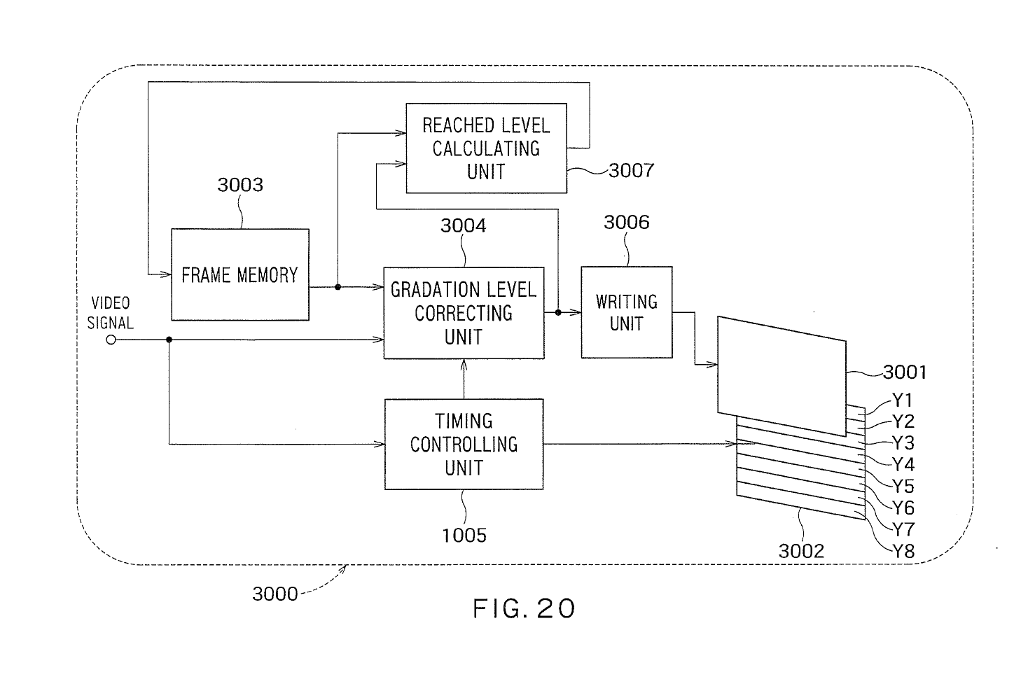

FIG. 20 is a block diagram showing a stereoscopic image display device 3000 according to the second embodiment.

A backlight 3002 is provided with eight emission units Y1 to Y8 extending in the horizontal direction of the screen, and the emission units Y1 to Y8 are adjacently arranged along the vertical direction of the screen. The emission units Y1 to Y8 can be thought to correspond to divided areas, respectively, which are obtained by vertically dividing the backlight in FIG. 2 into the areas. Each of the emission units Y1 to Y8 has a non-light emission period and a light emission period during one frame period or one sub-frame period. Though the light emission periods of the emission units differ from one another, the lengths of the periods are assumed to be the same. The light emission timing of the emission units is controlled by a timing controlling unit 3005 so that the lighting of the emission units is sequentially switched during one frame period. Each of the emission units is associated with a different area (the opposite area) of a liquid-crystal display unit 3001. A frame memory 3003, a writing unit 3006 and the liquid-crystal display unit 3001 have the same configuration of the components of the first embodiment having the same names. The operation of a gradation level correcting unit 3004 is extended according to change in the structure of the backlight. This extended operation will be mainly described below.

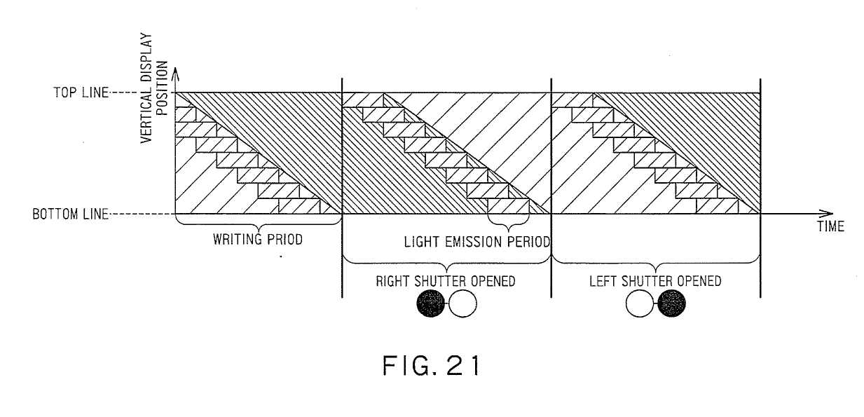

FIG. 21 is a time chart showing the relationship between writing of an image signal to the liquid-crystal display unit 3001 and the light emission timing of the backlight 3002. The glasses shutter opened period is assumed to be from the emission start time of the top emission unit Y1 of the backlight to the next emission start time of the top emission unit Y1.

In the case of the backlight by the whole surface emission method shown in the first embodiment, time required after start of writing until lighting of the backlight is shorter as the writing position on the liquid-crystal display unit is lower on the screen (see FIG. 8(B)). However, in the case of using the scan backlight method of this embodiment, the response time of the liquid crystal can be secured longer than the whole surface emission method even at the lower part of the screen, as can be understood from the figure. Therefore, in the case of adopting the scan backlight method (the case of performing lighting by the scan backlight method without performing the gradation correction of the first embodiment), occurrence of crosstalk is reduced in comparison with the case of adopting the whole surface emission method (the case of performing lighting by the whole surface emission method without performing the gradation correction of the first embodiment). However, even in the case of adopting the scan backlight method, crosstalk occurs after all similarly to the whole surface emission method if the liquid-crystal response is not completed before each emission unit emits light. Furthermore, response delay of the liquid-crystal glasses also causes crosstalk, similarly to the first embodiment.

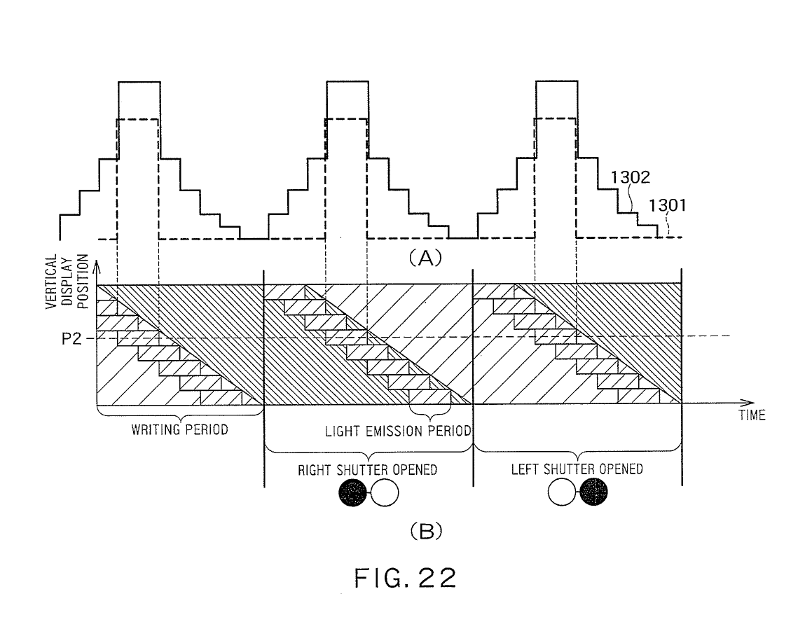

When the scan backlight method is adopted, it is conceivable to reduce crosstalk by performing gradation correction similar to the first embodiment for a processing-target pixel on the basis of the emission brightness of a corresponding emission unit. In the scan backlight method, however, light is radiated to a processing-target pixel not only by the corresponding emission unit but also by light leakage from surrounding emission units even during the time other than the light emission time of the corresponding emission unit. Therefore, sufficient reduction of crosstalk cannot be achieved unless correction is performed in consideration of this point. This will be further described in more detail with the use of FIG. 22.

FIG. 22(B) is the same diagram as FIG. 21, and FIG. 22(A) shows the amount of light at a vertical display position P2 along a time axis (in a lateral direction of the diagram). In an ideal response 1301 shown by a broken line, light enters a processing-target pixel only when a corresponding emission unit emits light, and light does not enter the processing-target pixel when the corresponding emission unit does not emit light. In an actual response 1302 shown by a solid line, however, incidence from surrounding emission units exits even when the corresponding emission unit does not emit light. Such light leakage becomes a factor in causing crosstalk.

Therefore, the gradation level correcting unit 3004 of this embodiment performs gradation correction of an input image signal in consideration of distribution of light leakage from surrounding emission units also. Concretely, when determining integrated intensity for a processing-target pixel, the gradation level correcting unit 3004 can use the total light intensity of light incident to the processing-target pixel from a light emission unit which is emitting light as backlight brightness, on the basis of light distribution at the time of radiating light from each light emission unit to the liquid-crystal display unit. It is assumed that the light distribution at the time of radiating light from each light emission unit to the liquid-crystal display unit is determined in advance.

The stereoscopic image display device of this embodiment is also capable of displaying a 2D image similarly to the first embodiment. In this case, the processing by the gradation level correcting unit 3004 is bypassed, and an image signal is outputted directly to the liquid-crystal display unit 3001 via the writing unit 3006. The timing controlling unit 3005 measures the writing time and executes only the processing for controlling lighting of the backlight 3002.

In this embodiment, crosstalk is reduced by gradation correction in consideration of light leakage. As another method, it is also possible to provide partitions among the light emission units so that light does not leak and perform gradation correction similarly to the first embodiment. In this case, however, attention should be paid to that uneven brightness occurs on the screen at the time of displaying a 2D image.

According to the embodiments described above, it is possible to provide a time-sharing stereoscopic image display device capable of significantly suppressing occurrence of crosstalk and a stereoscopic image display method.

The present invention is not limited to the exact embodiments described above and can be embodied with its components modified in an implementation phase without departing from the scope of the invention. Also, arbitrary combinations of the components disclosed in the above-described embodiments can form various inventions. For example, some of the all components shown in the embodiments may be omitted. Furthermore, components from different embodiments may be combined as appropriate.

1. A stereoscopic image display device displaying a stereoscopic image to an observer wearing glasses, the glasses controlling transmittance of light for a right eye and for a left eye, comprising:
a correction unit configured to correct gradation of pixels of a processing-target image signal for the right eye or for the left eye;
an image displaying unit configured to include a plurality of display pixels into which an image signal can be written;
a writing unit configured to write the image signal corrected by the correction unit into the display pixels of the image displaying unit;
a reached level calculation unit configured to calculate a reached gradation which is a gradation to be reached by each of the display pixels after one sub-frame period after the corrected image signal is written into the display pixel, on the basis of response characteristics of the display pixel, respectively; and
a timing controlling unit configured to control opening/closing timing of the glasses according to writing timing of the writing unit; wherein
the correction unit corrects the gradation of the pixels of the processing-target image signal, respectively, on the basis of a difference between the writing timing of the writing unit and the opening/closing timing of the glasses, and the reached gradation of the pixels in an immediately previous sub-frame.

2. The device according to claim 1, wherein the correction unit corrects the gradation of the pixels so that a difference between total integrated intensity and an expected value given in advance is minimized, or equal to or below a threshold, the total integrated intensity being obtained for each of the display pixels by integrating a product of display brightness of the display pixel and the transmittance of light for the right eye and for the left eye and performing summing up for a predetermined period.

3. A stereoscopic image display device displaying a stereoscopic image to an observer wearing glasses, the glasses controlling transmittance of light for a right eye and for a left eye by opening and closing, comprising:
a correction unit configured to correct gradation of pixels of a processing-target image signal for the right eye or for the left eye;
a backlight configured to emit light;
a liquid-crystal display unit configured to include a plurality of liquid-crystal pixels into which an image signal can be written and modulate light from the backlight on the basis of the image signal written into the liquid-crystal pixel;
a writing unit configured to write the image signal corrected by the correction unit into the liquid-crystal pixels of the liquid-crystal display unit;
a reached level calculation unit configured to calculate a reached gradation which is a gradation to be reached by the liquid-crystal pixel after one sub-frame period after the corrected image signal is written into the liquid-crystal pixels, on the basis of response characteristics of the liquid-crystal pixels, respectively; and
a timing controlling unit configured to control light emission timing of the backlight and opening/closing timing of the glasses according to writing timing of the writing unit; wherein
the correction unit corrects the gradation of the pixels of the processing-target image signal so that a difference between total integrated intensity and an expected value given in advance is minimized, or equal to or below a threshold, the total integrated intensity being obtained for each of the liquid-crystal pixels by integrating a product of liquid-crystal transmittance of the liquid-crystal pixel, light emission brightness of the backlight, and the transmittance of the light for the right eye and for the left eye and performing summing up for a predetermined period, on the basis of the reached gradation of the liquid-crystal pixel in an immediately previous sub-frame.

4. The device according to claim 3, wherein
the backlight includes a plurality of light emission units each of which is capable of switching light emission and non-light emission;
the timing controlling unit controls light emission timing of each of the light emission units; and
the correction unit corrects the gradation of the pixels so that a difference between total integrated intensity and the expected value is minimized, the total integrated intensity being obtained for each of the liquid-crystal pixels by integrating a product of total light intensity of the liquid-crystal pixel, the liquid-crystal transmittance of the liquid-crystal pixel, and the transmittance of the light for the right eye and for the left eye and performing summing up for a predetermined period, on the basis of light distribution on the liquid-crystal display unit at the time when each of the light emission units radiates light to the liquid-crystal display unit.

5. The device according to claim 4, wherein the expected value is the total integrated intensity in the case where a liquid-crystal response of the liquid-crystal pixel is a step response.

6. The device according to claim 3, wherein the correction unit corrects the gradation of the pixels of the processing-target image signal according to a light emission period of the backlight.

7. The device according to claim 1, wherein the correction unit corrects the gradation of the pixels of the processing-target image signal on the basis of at least one of a refresh rate of the sub-frame, temperature characteristics of the image displaying unit, and information inputted by a user.

8. The device according to claim 1, wherein the reached level calculating unit calculates the reached gradation on the basis of at least one of a refresh rate of the sub-frame and temperature characteristics of the image displaying unit.

9. A stereoscopic image display method displaying a stereoscopic image to an observer wearing glasses, the glasses controlling transmittance of light for a right eye and for a left eye, comprising:
correcting gradation of pixels of a processing-target image signal for the right eye or for the left eye;
writing the corrected image signal into display pixels in an image displaying unit;
calculating a reached gradation which is a gradation to be reached by each of the display pixels after one sub-frame period after the corrected image signal is written into the display pixel, on the basis of response characteristics of the display pixel, respectively; and
controlling opening/closing timing of the glasses according to writing timing of the corrected image signal into the display pixels; wherein
the correcting includes correcting the gradation of the pixels of the processing-target image signal, respectively, on the basis of a difference between the writing timing of the writing unit and the opening/closing timing of the glasses, and the reached gradation of the pixels in an immediately previous sub-frame.
